(19) United States
(12) Patent Application Publication
(10) Pub. No.: US 2013/0021645 A1
(43) Pub. Date: Jan. 24, 2013

(54) IMAGE FORMING APPARATUS, PRINTING CONTROL TERMINAL APPARATUS, PRINTING CONTROL METHOD THEREOF

(71) Applicant: Il-su LEE, Hwaseong-si (KR)

(72) Inventor: Il-su LEE, Hwaseong-si (KR)

(73) Assignee: Samsung Electronics Co., Ltd, Suwon-si (KR)

(21) Appl. No.: 13/445,964

(22) Filed: Apr. 13, 2012

(30) Foreign Application Priority Data
Jul. 19, 2011 (KR) 2011-0071628

(51) Int. Cl. G06K 15/02

(52) U.S. Cl. 358/1.15

(57) ABSTRACT

An image forming apparatus, a printing control terminal apparatus, and a printing control method thereof are provided. The method includes setting a division tab generation function which is to divide a printing target tab into page sections, dividing the printing target document into a plurality of page sections according to the division tab generation function, determining division tab positions according to the plurality of page sections, printing the printing target document, and performing cutting with respect to pages of the printed printing target document in the determined division tab positions to generate division tabs.

### CROSS-REFERENCE TO RELATED APPLICATIONS

This application claims priority under 35 U.S.C. §119 from Korean Patent Application No. 10-2011-0071628, filed on Jul. 19, 2011, in the Korean Intellectual Property Office, the disclosure of which is incorporated herein by reference in its entirety.

### BACKGROUND

1. Field of the General Inventive Concept

The present general inventive concept generally relates to an image forming apparatus, a printing control terminal apparatus, and a printing control method thereof, and more particularly, to an image forming apparatus which can control a post-processing function, a printing control terminal apparatus, and a printing control method thereof.

2. Description of the Related Art

With the development of electronic technology, peripheral devices, such as computers, printers, scanners, etc., have been actively distributed. In particular, manufacturing companies have participated in the development of printers and have developed post-processing functions such as a mailbox, a finisher, a booklet, etc.

When outputting a large document which can be divided into chapters, a user directly adds tabs or marks in order to divide the document into chapters. A printed matter, which has been printed to several copies or has been divided into many chapters by the user, requires a great deal of care from the user when being bound. Therefore, much time and cost are taken in these efforts.

Also, in order to make intaglio tabs to divide chapters from one another, the user is to output a whole part of a document and then manually make intaglios using a particular apparatus for binding. Accordingly, additional cost is incurred, and the user must look for methods and apparatuses to bind the parts of the document together. Therefore, time and space waste occurs.

### SUMMARY OF THE INVENTION

The present general inventive concept provides an image forming apparatus which can provide a division tab setting function which is to divide a printing target document into a plurality of page sections, a printing control terminal apparatus, and a printing control method thereof.

Additional embodiments of the present general inventive concept will be set forth in part in the description which follows and, in part, will be obvious from the description, or may be learned by practice of the general inventive concept.

Embodiments of the present general inventive concept may be achieved by providing a printing control method, including setting a division tab generation function which is to divide a printing target tab into page sections, dividing the printing target document into a plurality of page sections according to the division tab generation function, determining division tab positions according to the plurality of page sections, printing the printing target document, and performing cutting with respect to pages of the printed printing target document in the determined division tab positions to generate division tabs.

The printing control method may further include providing a menu which is to set the division tab generation function. The menu may include at least one of an auto setup option, a manual setup option, and a one copy division tab setup option.

If the auto setup option is selected, preset information may be read from the printing target document, and the printing target document may be divided into the plurality of page sections by using the read information.

If the manual setup option is selected, the printing target document may be divided into the plurality of page sections according to page information input by a user.

If the one copy division tab setup option is selected, the printing target document may be divided into the plurality of page sections according to information input with respect to each of a plurality of printing target documents.

When generating the division tabs, an intaglio tab may be generated so that cutting sizes of pages before a first page constituting one of the plurality of page sections sequentially decrease.

When generating the division tabs, a reverse intaglio tab may be generated so that cutting sizes of pages after a first page constituting one of the plurality of page sections sequentially decrease.

The printing control method may further include providing a preview function of the determined division tab positions and the number of division tabs.

The printing target document may be a manuscript.

Embodiments of the present general inventive concept may also be achieved by providing an image forming apparatus, including a user interface unit to set a division tab generation function which is to divide a printing target document into a plurality of page sections, a division tab setter to divide the printing target document into the plurality of page sections according to the division tab generation function and determine division tab positions according to the plurality of page sections, an output unit to print the printing target document, and a controller to control a printing post-processing apparatus to perform cutting with respect to pages of the printed printing target document in the determined division tab positions in order to generate division tabs.

The user interface unit may provide a menu which is to set the division tab generation function. The menu may include at least one of an auto setup option, a manual setup option, and a one copy division tab setup option.

If the auto setup option is selected, the controller may read preset information from the printing target document and divide the printing target document into the plurality of page sections by using the read information.

If the manual setup option is selected, the controller may divide the printing target document into the plurality of page sections according to page information input by a user.

If the one copy division tab setup option is selected, the controller may divide the printing target document into the plurality of page sections according to information input with respect to each of a plurality of printing target documents.

The controller may control a printing post-processing apparatus to generate an intaglio tab so that cutting sizes of pages before a first page constituting one of the plurality of page sections sequentially decrease or a reverse intaglio tab so that cutting sizes of pages after a first page constituting one of the plurality of page sections sequentially decrease.

Embodiments of the present general inventive concept may also be achieved by providing a printing control terminal apparatus connected to an image forming apparatus, the printing control terminal apparatus including a user interface unit to set a division tab generation function which is to divide a printing target document into a plurality of page sections, a division tab setter to divide the printing target document into the plurality of page sections according to the division tab generation function and determine division tab positions according to the plurality of page sections, and a controller to control a printing post-processing apparatus to perform cutting with respect to pages of the printing target document printed through the image forming apparatus in the division tab positions in order to generate division tabs.

The user interface unit may provide a menu which is to set the division tab generation function. The menu may include at least one of an auto setup option, a manual setup option, and a one copy division tab setup option.

If the auto setup option is selected, the controller may read preset information from the printing target document and divide the printing target document into the plurality of page sections by using the read information.

If the manual setup option is selected, the controller may divide the printing target document into the plurality of page sections according to page information input by a user, and if the one copy division tab setup option is selected, the controller may divide the printing target document into the plurality of page sections according to information input with respect to each of a plurality of printing target documents.

The user interface unit may provide a preview function of the determined division tab positions and the number of division tabs.

Embodiments of the present general inventive concept may also be achieved by providing a printing control method, including receiving print data of a target document, determining whether the target document is to be divided into chapters, determining whether a post-print apparatus has a tab-cutting function, determining a number of chapters in the target document and determining cutting positions of tabs, and printing the target document and performing a cutting operation to form division tabs to correspond to the number of chapters.

The method may further include forming different depth division tabs in the printed target document.

The method may further include forming at least one small depth division tab near the front of the printed target document and forming at least one large depth division tab near the back of the printed target document.

The cutting positions of the tabs may be determined by a user. The cutting positions of the tabs may also determined by a controller.

The method may also include forming second division tabs between the chapters, offset from the chapter division tabs.

### BRIEF DESCRIPTION OF THE DRAWINGS

These and/or other features and utilities of the present general inventive concept will become apparent and more readily appreciated from the following description of the embodiments, taken in conjunction with the accompanying drawings of which:

FIG. 1 is a block diagram illustrating a structure of an image forming apparatus according to an exemplary embodiment of the present general inventive concept;

FIG. 2 is a block diagram illustrating a structure of a printing control terminal apparatus according to an exemplary embodiment of the present general inventive concept;

FIG. 3 is a view illustrating a menu format which is to set a division tab generation function according to an exemplary embodiment of the present general inventive concept;

FIGS. 4 is a flowchart illustrating a cutting operation to generate one or more division tabs according to an exemplary embodiment of the present general inventive concept;

FIG. 5A is a view illustrating a method of generating a forward intaglio tab and FIG. 6A illustrates a bound volume having forward intaglio tabs according to an exemplary embodiment of the present general inventive concept;

FIG. 5B is a view illustrating a method of generating a backward intaglio tab and FIG. 6B illustrates a bound volume having backward intaglio tabs according to an exemplary embodiment of the present general inventive concept; and

FIG. 7 is a flowchart illustrating a printing control method of an image forming apparatus according to an exemplary embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to like elements throughout. The embodiments are described below in order to explain the present general inventive concept by referring to the figures.

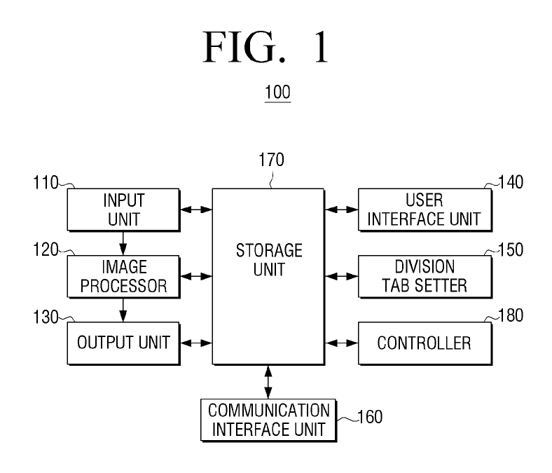

FIG. 1 is a block diagram illustrating a structure of an image forming apparatus 100 according to an exemplary embodiment

Referring to FIG. 1, the image forming apparatus 100 is connected to an external device, supports a resource saving mode, and outputs document data. The image forming apparatus 100 may be realized in various forms such as a printer, a scanner, a copier, a fax machine, a multifunction peripheral (MFP) having at least two or more of functions of the printer, scanner, and fax machine, etc.

An input unit 110 receives image data which is to be image-processed.

In more detail, the input unit 110 may receive and/or generate a printing image or a scanned image. In other words, the input unit 110 may receive an image which is generated through an application program or a driver of a host device (not illustrated) or an RGB rendering image which is generated through an emulation. Alternatively, in the case of a copier or scanner, the input unit 110 may receive an image which is scanned by an RGB or similar sensor.

A rendering unit (not illustrated) converts image data received through the input unit 110 into bitmap data of an RGB space.

An image processor 120 performs image processing with respect to input data under control of a controller 180.

In more detail, the image processor 120 may convert an 8-bit RGB image into a CMYK color image through a color conversion, perform an image quality improvement with respect to the CMYK color image, and generate the CMYK color image as a 1-bit image (binary data) through halftoning.

An output unit 130 prints data, which is image-processed by the image processor 120, on a recording medium under control of the controller 180. The output unit 130 may include a printing unit of a printer, scanner, or multifunctional peripheral as described herein.

For example, in the case of a laser type image forming apparatus, a surface of an Organic Photo Conductor (OPC) is charged by a charging unit (not illustrated), and a latent image is formed on the charged area of the surface of the OPC by a laser scanning unit (LSU) (not illustrated). If the latent image is developed by a developing unit (not illustrated) in this state, toner sticks to the latent image. Therefore, toner may be transferred to a recording medium, such as a printing paper by a transfer unit (not illustrated). The transferred toner is fixed onto the printing paper by a fixing unit (not illustrated).

A user interface unit 140 may include one or more control keys (not illustrated) to input user commands to control operations of the image forming apparatus 100. The user interface unit 140 may include a display window (not illustrated) to display a state of the image forming apparatus 100, such as a liquid crystal display (LCD). The user interface unit 140 may be realized as a device, which simultaneously realizes an input and an output, such as a touch pad. The user interface unit 140 may include a keyboard interface that enables a user to input information to be processed. The user interface unit 140 may include a mouse-type device in which a user may manipulate data on a computer screen.

The user interface unit 140 may also display various types of information provided from the image forming apparatus 100 including details and results of a job which is in progress in the image forming apparatus 100. The user may check, manage, and control various types of printing jobs of the image forming apparatus 100 through the user interface unit 140.

In particular, the user interface unit 140 may set a division tab generation function to divide a printing target document into a plurality of page sections.

In more detail, the user interface unit 140 may provide a menu to set the division tab generation function. The menu may include at least one of an auto setup option, a manual setup option, and a one copy division tab setup option.

Also, the user interface unit 140 may provide a preview function of the number and positions of determined division tabs.

If the division tab generation function is set through the user interface unit 140, a division tab setter 150 divides the printing target document into a plurality of page sections and determines the number and positions of division tabs according to the plurality of page sections.

If the number and positions of the division tabs of the printing target document are set by the division tab setter 150, this information may be provided in a preview format to the user through the user interface unit 140. The output unit 130 prints the printing target document according to the user command.

The controller 180 controls operations of elements of the image forming apparatus 100 according to various types of pre-stored programs.

In particular, if the printing target document in which the number and positions of the division tabs have been set is completely printed, the controller 180 may control a printing post-processing apparatus, e.g., a cutter, to generate division tabs of the printed printing target document. Here, the cutter may be included in a finisher of the printing post-processing apparatus or may be realized separately from the finisher.

A communication interface unit 160 may support data communications which are performed with an external device (not illustrated) through a network. For example, the communication interface unit 160 may be realized in a form which can support a Digital Living Network Alliance (DLNA) network, a local system, a local area network (LAN), and the Internet. The external device may be a host device such as a personal computer (PC).

A storage unit 170 may be realized as a storage medium of the image forming apparatus 100 or an external storage medium, e.g., a removable disk including a universal serial bus (USB) memory, a storage medium connected to a host, a web server through a network, or the like.

The storage unit 170 stores various types of information related to the division tab generation function. For example, the storage unit 170 may store various types of information regarding an intaglio tab generation form, the number of division tabs, a position setting method, etc.

If an auto setup option is selected through the user interface unit 140, the controller 180 may control the division tab setter 150 to read preset information from the printing target document and divide the printing target document into a plurality of page sections using the read information.

If a manual setup option is selected through the user interface unit 140, the controller 180 may control the division tab setter 150 to divide the printing target document into a plurality of page sections according to page information input by the user.

If a one copy division tab setup option is selected through the user interface unit 140, the controller 180 control the division tab setter 150 to divide the printing target document into a plurality of page sections according to information input with respect to each of a plurality of printing target documents.

The controller 180 may control the printing post-processing apparatus to generate an intaglio tab by cutting a plurality of shapes having different sizes into a plurality of pages. These tabs may be generated and cut before a first page constituting one of the plurality of page sections and throughout a bound document. When forward intaglio tabs are generated, the tabs may be sequentially reduced in size according to a user selection.

The controller 180 may control the printing post-processing apparatus to generate a backward intaglio tab by cutting sizes of pages after a first page constituting one of the plurality of page sections, in which the sizes off the tabs are sequentially reduced according to a user selection.

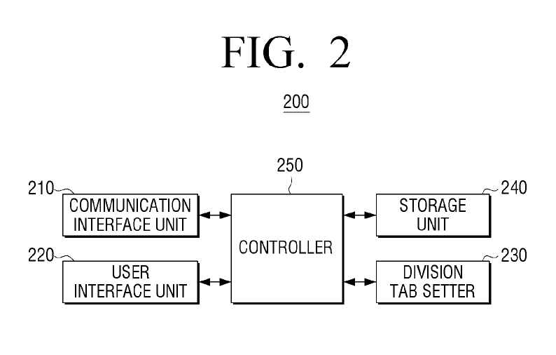

In the present exemplary embodiment, functions related to setting division tabs are controlled by elements of the image forming apparatus 100, but this is only an embodiment. Therefore, all of the above-described functions may be controlled by a printer driver (not illustrated) or an application (not illustrated) of a host device (not illustrated) connected to the image forming apparatus 100. This will be described with reference to FIG. 2.

FIG. 2 is a block diagram illustrating a structure of a printing control terminal apparatus 200 according to an exemplary embodiment.

Referring to FIG. 2, the printing control terminal apparatus 200 supports a resource saving mode and is connected to an image forming apparatus which outputs document data. The printing control terminal apparatus 200 may be a PC, a notebook computer, a personal digital assistant (PDA), a portable multimedia player (PMP), a mobile phone, or the like.

A communication interface unit 210 may be connected to at least one image forming apparatus and provides converted printing data (converted document data, selected output option information, etc.) of a printing job to the image forming apparatus. In more detail, the communication interface unit 210 is formed to connect the printing control terminal apparatus 200 to the image forming apparatus and may be realized as a CD drive, a USB port, a wireless module, or the like.

The communication interface unit 210 may receive a pre-scanned or main-scanned image of a scan target page from the image forming apparatus.

A user interface unit 220 includes a plurality of function keys which are used by a user to set or select various types of functions supported by the printing control terminal apparatus 200. The user interface unit 220 may be realized as a device which simultaneously realizes an input and an output, such as a touch pad or the like or may be realized as a mouse. The user may select document data, which is to be output through the image forming apparatus connected through the communication interface unit 210, through the user interface unit 220 and select an output option which is to be applied to the selected document data.

The user interface unit 220 may also display various types of information provided by the printing control terminal apparatus 200.

In particular, the user interface unit 220 may set a division tab generation function which is to divide a printing target document into a plurality of page sections.

In more detail, the user interface unit 220 may provide a menu which is to set the division tab generation function. Here, the menu may include at least one of an auto setup option, a manual setup option, and a one copy division tab setup option.

The user interface unit 220 provides a preview function to input and display the number and positions of determined division tabs.

An object and a display form displayed on the user interface unit 220 are the same as those displayed on a display unit of the image forming apparatus 100 of FIG. 1, and thus their detailed descriptions will be omitted.

If the division tab generation function is set through the user interface unit 220, a division tab setter 230 divides the printing target document into a plurality of page sections and determines the number and positions of division tabs according to the plurality of page sections.

If the number and positions of division tabs of the printing target document are set by the division tab setter 230, this may be provided in a preview format to the user through the user interface unit 220.

A function of the division tab setter 230 may be performed by a printer driver of an image forming apparatus such as a printer apparatus. The printer driver may include at least one driver to correspond to at least one language and perform a printing job of an image forming apparatus which operates in the at least one language. In more detail, if the user wants to print a document which has been written by an application program, the printer driver may generate printing data in a recognizable printing language format in the image forming apparatus in which the user wants to perform a printing job.

A storage unit 240 may store image forming apparatus information received from the communication interface unit 210. The storage unit 240 may temporarily store the printing data generated by the printer driver and may pre-store a scripter which stores printing options supported according to models of image forming apparatuses, supported printing language information, etc.

A controller 250 controls operations of elements of the printing control terminal apparatus 200 according to various types of pre-stored programs.

The controller 250 controls an element, which is necessary to perform a printing job according to an output option selected in an image forming apparatus, by using the printing driver.

In particular, if the printing target document in which the number and positions of division tabs have been set is completely printed, the controller 250 may control a printing post-processing apparatus to generate division tabs of the printed printing target document.

In more detail, the controller 250 may inform a finisher of the printing post-processing apparatus of start/end pages of an intaglio tab, a cutting range, and the like. This may be a printer job language (PJL) command or a particular command of output data and may include data on a position of an intaglio tab, a start page, an end page, the number of intaglio tab constituting pages, etc.

Therefore, the finisher may control a position of a cutter and a cutting time according to received information.

It will be obvious to those of ordinary skill in the art that the printing control terminal apparatus 200 may form structures applied to the image forming apparatus 100 of FIG. 1 within a range of a possible image forming job, by using the printer driver. Therefore, its detailed description will be omitted.

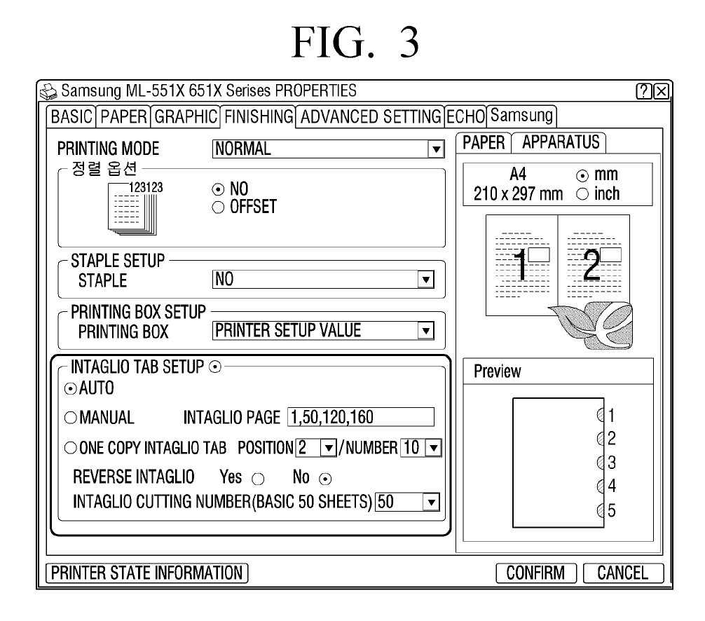

FIG. 3 is a view illustrating a menu format which is to set a division tab generation function, according to an exemplary embodiment.

In the present exemplary embodiment of FIG. 3, for the descriptive convenience, the menu format is provided from a printer driver of a printing control terminal apparatus. Hereinafter, division tabs will be referred to as intaglio tabs.

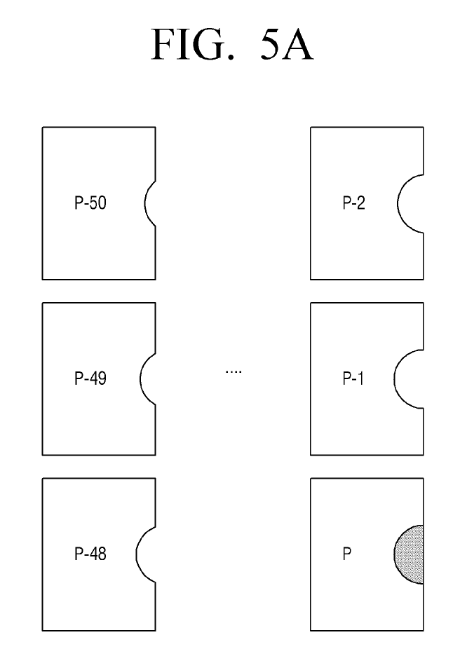

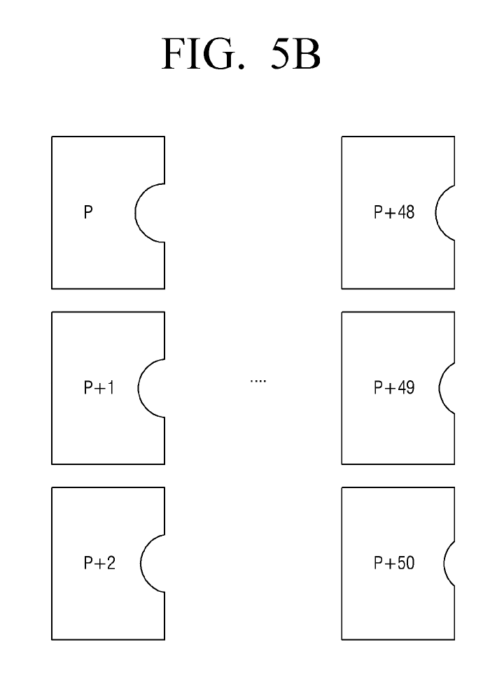

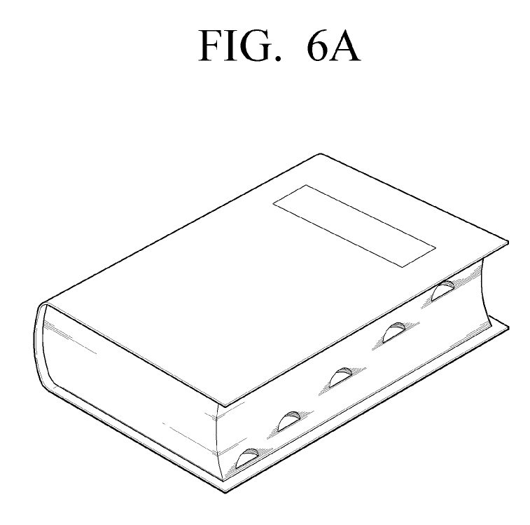

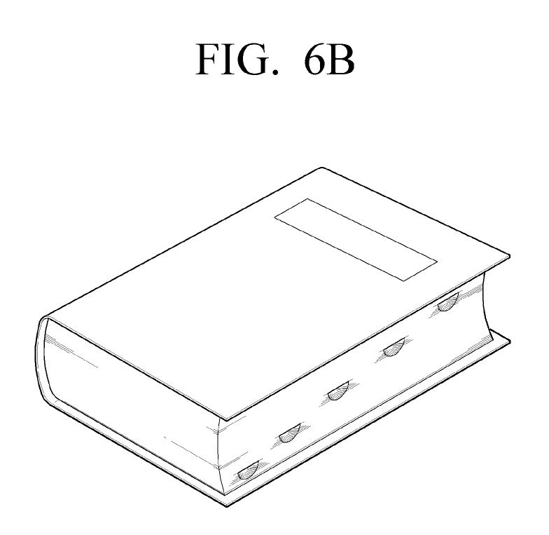

Division tabs or intaglio tabs refer to indentations made in a bound, printed volume of recording sheets, such as a curved notch, or carved out section. Examples of division tabs or intaglio tabs are illustrated in FIGS. 5A, 5B, 6A and 6B, but the present general inventive concept is not limited thereto. The division tables or intaglio tabs may be formed of other shapes such as triangular, rectangular, and other shapes as is known in the art.

Referring to FIG. 3, a menu, which is to set an intaglio tab generation function, may include an auto setup option, a manual setup option, and a one copy intaglio tab setup option. Therefore, a user may select a desired option using one or more elements of the user interface unit such as a keyboard, mouse or touch screen panel. A method for generating intaglio tabs according to each setup option will now be described.

Auto Setup Option

According to an exemplary embodiment, if the user selects the auto setup option, the user may use the controller 180 to automatically calculate the number and positions of intaglio tabs by using preset information included in a printing target document.

For example, if a page connected to a content table of PDF or Microsoft Word is set to a chapter of an intaglio tab, the user may use the controller 180 to calculate the total number of chapters and divide a length of a side of a printing paper by “the number of chapters +1” to determine positions of division tabs.

In more detail, if 10 chapters exist, and the length of the side of the printing paper is 297 mm, positions of division tabs may be determined in the unit of 27 mm which is obtained by dividing 297 mm by 11 (the number of chapters +1).

In other words, a position of a first intaglio tab may be at 27 mm from a top of the printing paper, and a position of a second intaglio tab may be at 54 mm from the top of the printing paper. A position of a third intaglio tab may be at 81 mm from the top of the printing paper, and a position of a tenth intaglio tab may be at 270 mm from the top of the printing paper.

The present general inventive concept is not limited to this arrangement. In addition, a controller 180 may be programmed to set the locations of the intaglio tabs at distances that are not equidistant from each other.

Also, the controller 180 may determine the lengths of the chapters, and insert additional intaglio tabs at midway points of chapters, offset from the chapter tabs. A controller 180 may be instructed to do this, if for example, chapters have a total volume over a given threshold. To add additional intaglio tabs between chapters in this manner may be helpful to a user to prevent flipping through large chunks of a bound document at once, which can be cumbersome, as well as put extra strain on the binding apparatuses of the bound document.

Manual Setup Option

According to another exemplary embodiment, if the user selects the manual setup option, intaglio tabs may be set on a printing page set by the user at desired positions that may or may not be equidistant apart.

One Page Intaglio Tab Setup Option

According to another exemplary embodiment, the user may select a one copy intaglio tab option to manually set intaglio tabs with respect to a plurality of printing target documents.

In other words, if the user selects the one copy intaglio tab option, the user may set the number and positions of intaglio tabs of each of the plurality of printing target documents to be printed and cut in succession.

For example, in order to bind ten different printing target documents into one book, the ten different printing target documents are to be respectively printed. In this case, a first document is set to 1/10, a second document is set to 2/10, a third document is set to 3/10, and a tenth document is set to 10/10. Therefore, intaglio tabs may be set with respect to each of the plurality of printing target documents to bind the plurality of printing target documents into one book.

As illustrated in FIG. 3, according to various exemplary embodiments, a reverse intaglio tab setup function, an intaglio cutting number setup function, etc. may be provided. Here, the intaglio cutting number setup function refers to a function of setting the number of pages which are cut to set one intaglio tab. Also, the reverse intaglio tab setup function refers to a function of reversely setting an intaglio tab. This will be described later with reference to the drawings.

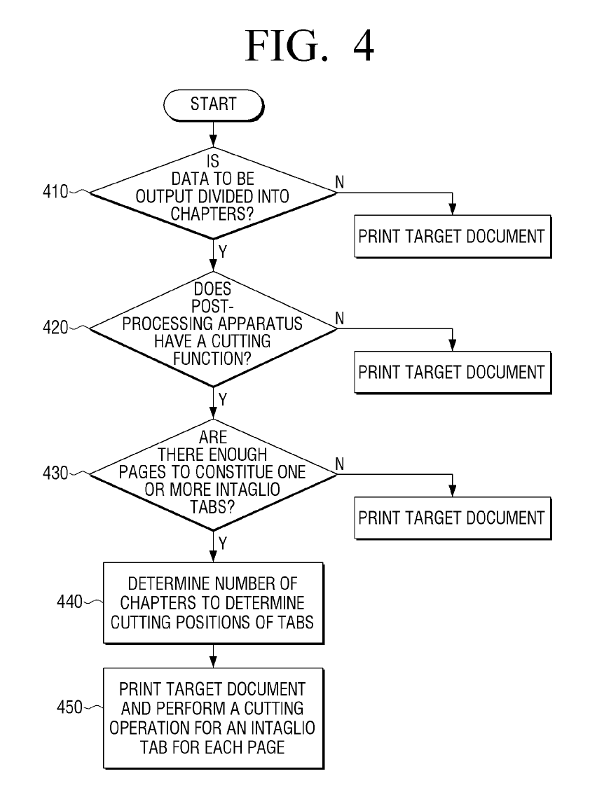

FIG. 4 is a flowchart illustrating a method of performing a cutting operation to generate one or more division or intaglio tabs according to an exemplary embodiment.

As illustrated in FIG. 4, in operation 410, whether data to be output is divided into chapters and whether it is possible to divide chapters from one another in order to constitute intaglio tabs are checked. If Yes, the process continues to operation 420 to determine whether a post-processing apparatus has a tab cutting function. If yes, the controller determines in operation 430 whether pages before a chapter are enough to constitute one or more intaglio tabs. If the controller 180, after interpreting the printing target documents, determines that none of these three operations are met (N), then the controller discontinues the inquiries and send the target document to be printed without intaglio tabs.

Once it is determined that there are enough pages to constitute one or more intaglio tabs, in operation 440, the number of chapters to be divided from one another may be checked to determine cutting positions of intaglio tabs. This may be done using the formula described above, in which a number of chapters is identified, a length of a printing medium is identified, and positions of division tabs are determined by dividing the medium length by a number that is +1 more than the number of chapters. This may be appropriately adjusted according to a length of a side of a printed matter and the number of output pages. Also, manual inputs may determine the placement of intaglio tabs.

In operation 450, once an output unit performs printing, and pages having intaglio or other tabs to be cut to constitute intaglio tabs are output, a post-processing apparatus (e.g., a finisher and a cutter) performs a cutting operation for the intaglio tabs with respect to each page based on a user selected forward or backward type of intaglio or other division tab.

FIG. 5A is a view illustrating a method for generating forward intaglio tabs according to an exemplary embodiment and FIG. 6A illustrates a bound volume having forward intaglio tabs.

As illustrated in FIG. 5A, cutting is performed with respect to previous pages of a page section to be divided to generate an intaglio tab.

If a cutter has a circular shape having a fixed diameter, the cutter moves to a region of a page to be cut as directed by the controller 180 to perform cutting (from P−50 to P−1) so that sizes of cutting areas gradually increase from top to bottom. Here, P indicates a first page of a chapter, P−50 indicates a second page of a chapter, P−1 indicates a page before the first page of the chapter, and P−2 indicates a page before the page before the first page of the chapter. In other words, P−1 indicates the last page of a previous chapter and P−2 represents the page before the last page of a previous chapter. Note here that 50 is just an exemplary number, and that chapters may have various lengths greater than and less than 50 pages.

Thus, when forming a forward intaglio tab structure, as illustrated in FIG. 5A by the darkened arc-shape, a first page P of a target chapter is not cut to complete an intaglio tab.

FIG. 5B is a view illustrating a method for generating a backward intaglio tab (reverse intaglio tab) according to another exemplary embodiment and FIG. 6B illustrates a bound volume having forward intaglio tabs.

As illustrated in FIG. 5B, cutting is performed in an opposite order to the method of FIG. 5A to generate a backward intaglio tab.

Differently than a forward intaglio tab, to form a backward intaglio tab a cutter moves toward an edge of pages to perform cutting (from P to P+50) so that sizes of cutting areas of a backward intaglio tab gradually decrease from top to bottom. Here, P denotes a first page of a chapter, P+1 denotes a page next to the first page of the chapter, P+2 denotes a page after the page next to the first of the chapter, and P+50 represents the last page of a chapter, with no cut-out arc shape. In this case, differently from a forward intaglio tab, a first page P of a target chapter may have a cut-out portion to complete the entire intaglio tab.

If several documents which are not divided into chapters are output together, each of the documents may be regarded as a chapter to constitute an intaglio tab. For example, if a list of documents to be output is input, each of the documents may be regarded as a chapter to constitute an intaglio tab. In this case, the total number of documents in the list is determined as the total number of chapters, and positions of intaglio tabs are determined in orders of the document of the list to perform cutting.

Although the present general inventive concept illustrates intaglio tabs having the same arc curvature and depth as illustrated in FIGS. 6A and 6B, the present general concept is not limited thereto. Division or intaglio tabs of the present general inventive concept may have different arc sizes/depts, in which a user is able to flip through a document. For example, for a smaller document having less pages between chapters, smaller depth intaglio tabs can be cut into a bound document, while in larger bound documents, when more pages must be turned at once, a larger intaglio tab may be used.

Also, different depth arc-shapes may be used in the same bound document. For example, closer to the front of the document when pages to be turned are less, a smalled depth division or intaglio tab may be used. In the middle sections of the document, medium depth tabs may be used, and towards the end of the bound document where more pages may need to be turned at once, larger depth tabs may be used. The controller 180 may be programmed to implement these varied use tabs based on the chapter length, as indicated in input data, or a user may make these selections.

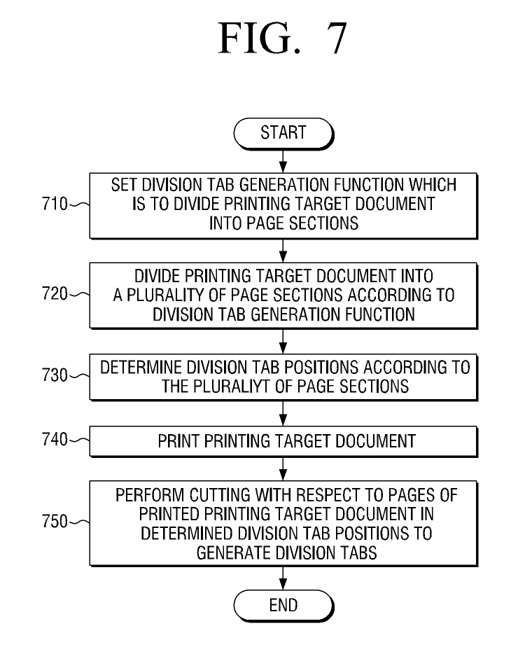

FIG. 7 is a flowchart illustrating a printing control method of an image forming apparatus according to an exemplary embodiment.

Referring to FIG. 7, in operation 710, a division tab generation function, which is to divide a printing target document into page sections, is set. In operation 720, the printing target document is divided into a plurality of page sections according to the division tab generation function. Here, the printing target document may be a manuscript.

In operation 730, positions of division tabs are determined according to the plurality of page sections.

In operation 740, the printing target document is printed.

In operation 750, cutting is performed with respect to the pages of the printed printing target document in the positions of the division tabs to generate division tabs.

Additional detail is provided regarding the operations. In operation 710, a menu for setting the division tab generation function may be provided. In this case, the menu may include at least one of an auto setup option, a manual setup option, and a one copy division tab setup option.

In operation 720, if the auto setup option is selected, preset information may be read from the printing target document, and the printing target document may be divided into the plurality of page sections using the read information.

Also, in operation 720, if the manual setup option is selected, the printing target document may be divided into the plurality of page sections according to page information input by a user.

In operation 720, if the one copy division tab setup option is selected, the printing target document may be divided into the plurality of page sections according to information input with respect to each of a plurality of printing target documents.

In operation 750, an intaglio tab may be generated so that cutting sizes of pages before a first page constituting one of the plurality of page sections sequentially decrease. Alternatively the intaglio tab may be generated so that cutting sizes after a last page sequentially increase.

Also, in operation 750, a reverse intaglio tab may be generated so that cutting sizes of pages after a first page constituting one of the plurality of page sections sequentially decrease. Alternatively, the reverse intaglio tab may be generated so that cutting sizes of pages before a last page sequentially increase.

A preview function of the positions and the number of division tabs determined in operation 730 may be provided.

If an image forming method according to the present general inventive concept is performed in a printing control terminal apparatus, the image forming method may be the same as the printing control method of the image forming apparatus illustrated in FIG. 6 except for functions performed in the image forming apparatus, i.e., a printing function and a cutting function. Therefore, its detailed description will be omitted.

Therefore, when a user prints a large amount of document, the user may set dividers with respect to chapters to easily search for the chapters.

Also, intaglio tabs may be constituted through a cutting apparatus having a simple circular shape. Therefore, convenience may be provided to a small number of users.

In addition, an intaglio tab generation function may be added to a large-sized printing apparatus such as a copier having a bookbinding function so as to provide convenience to a user.

A storage medium storing a program for executing a printing control method may, i.e., a computer readable recording medium, include all types of recording devices which store data which can be read by a computer system. Examples of the computer readable recording medium include a ROM, a RAM, a CD-ROM, a magnetic tape, a floppy disk, an optical data storage device, etc. The computer readable recording medium can also be distributed over network coupled computer systems so that a computer readable code is stored and executed in a distributed fashion.

Although various example embodiments of the present general inventive concept have been illustrated and described, it will be appreciated by those skilled in the art that changes may be made in these example embodiments without departing from the principles and spirit of the general inventive concept, the scope of which is defined in the appended claims and their equivalents.

What is claimed is:

1. A printing control method comprising:
setting a division tab generation function which is to divide a printing target document into page sections;
dividing the printing target document into a plurality of page sections according to the division tab generation function;
determining division tab positions according to the plurality of page sections;
printing the printing target document; and
performing cutting with respect to pages of the printed printing target document in the determined division tab positions to generate division tabs.

2. The printing control method as claimed in claim 1, further comprising providing a menu which is to set the division tab generation function,
wherein the menu comprises at least one of an auto setup option, a manual setup option, and a one copy division tab setup option.

3. The printing control method as claimed in claim 2, wherein the dividing the printing target document into a plurality of page sections reads preset information from the printing target document and divides the printing target document into the plurality of page sections by using the read information if the auto setup option is selected.

4. The printing control method as claimed in claim 2, wherein the dividing the printing target document into a plurality of page sections divides the printing target document into the plurality of page sections according to page information input by a user if the manual setup option is selected.

5. The printing control method as claimed in claim 2, wherein the dividing the printing target document into a plurality of page sections divides the printing target document into the plurality of page sections according to information input with respect to each of a plurality of printing target documents if the one copy division tab setup option is selected.

6. The printing control method as claimed in claim 1, wherein the generating division tabs generates an intaglio tab so that cutting sizes of pages before a first page constituting one of the plurality of page sections decrease sequentially.

7. The printing control method as claimed in claim 1, wherein the generating division tabs generates a reverse intaglio tab so that cutting sizes of pages after a first page constituting one of the plurality of page sections decrease sequentially.

8. The printing control method as claimed in claim 7, further comprising providing a preview function of the determined division tab positions and the number of division tabs.

9. The printing control method as claimed in claim 1, wherein the printing target document is a manuscript.

10. An image forming apparatus comprising:
a user interface unit to set a division tab generation function which is to divide a printing target document into a plurality of page sections;
a division tab setter to divide the printing target document into the plurality of page sections according to the division tab generation function and determine division tab positions according to the plurality of page sections;
an output unit to print the printing target document; and
a controller to control a printing post-processing apparatus to perform cutting with respect to pages of the printed printing target document in the determined division tab positions in order to generate division tabs.

11. The image forming apparatus as claimed in claim 10, wherein the user interface unit provides a menu which is to set the division tab generation function,
wherein the menu comprises at least one of an auto setup option, a manual setup option, and a one copy division tab setup option.

12. The image forming apparatus as claimed in claim 11, wherein the controller reads preset information from the printing target document and divides the printing target document into the plurality of page sections by using the read information if the auto setup option is selected.

13. The image forming apparatus as claimed in claim 11, wherein the controller divides the printing target document into the plurality of page sections according to page information input by a user if the manual setup option is selected.

14. The image forming apparatus as claimed in claim 11, wherein the controller divides the printing target document into the plurality of page sections according to information input with respect to each of a plurality of printing target documents if the one copy division tab setup option is selected.

15. The image forming apparatus as claimed in claim 10, wherein the controller controls the printing post-processing apparatus to generate an intaglio tab so that cutting sizes of pages before a first page constituting one of the plurality of page sections decrease sequentially or a reverse intaglio tab so that cutting sizes of pages after a first page constituting one of the plurality of page sections decrease sequentially.

16. A printing control terminal apparatus connected to an image forming apparatus, the printing control terminal apparatus comprising:
a user interface unit to set a division tab generation function which is to divide a printing target document into a plurality of page sections;
a division tab setter to divide the printing target document into the plurality of page sections according to the division tab generation function and determine division tab positions according to the plurality of page sections; and
a controller to control a printing post-processing apparatus to perform cutting with respect to pages of the printing target document printed through the image forming apparatus in the division tab positions in order to generate division tabs.

17. The printing control terminal apparatus as claimed in claim 16, wherein the user interface unit provides a menu which is to set the division tab generation function,
wherein the menu comprises at least one of an auto setup option, a manual setup option, and a one copy division tab setup option.

18. The printing control terminal apparatus as claimed in claim 17, wherein the controller reads preset information from the printing target document and divides the printing target document into the plurality of page sections by using the read information if the auto setup option is selected.

19. The printing control terminal apparatus as claimed in claim 17, wherein, if the manual setup option is selected, the controller divides the printing target document into the plurality of page sections according to page information input by a user, and if the one copy division tab setup option is selected, the controller divides the printing target document into the plurality of page sections according to information input with respect to each of a plurality of printing target documents.

20. The printing control terminal apparatus as claimed in claim 16, wherein the user interface unit provides a preview function of the determined division tab positions and the number of division tabs.

21. A printing control method, comprising:
receiving print data of a target document;
determining whether the target document is to be divided into chapters;
determining whether a post-print apparatus has a tab-cutting function;
determining a number of chapters in the target document and determining cutting positions of tabs; and
printing the target document and performing a cutting operation to form division tabs to correspond to the number of chapters.

22. The printing control method of claim 21, further comprising forming different depth division tabs in the printed target document.

23. The printing control method of claim 22, further comprising forming at least one small depth division tab near the front of the printed target document and forming at least one large depth division tab near the back of the printed target document.

24. The printing control method of claim 21, wherein the cutting positions of the tabs are determined by a user.

25. The printing control method of claim 21, wherein the cutting positions of the tabs are determined by a controller.

26. The printing control method of claim 21, further comprising forming second division tabs between the chapters, offset from the chapter division tabs.
